(19) United States
(12) Patent Application Publication
(10) Pub. No.: US 2024/0309263 A1
(43) Pub. Date: Sep. 19, 2024

(54) SOY BASED CORROSION INHIBITION PRODUCTS FOR OIL AND GAS APPLICATIONS

(71) Applicant: ChampionX LLC, Sugar Land, TX (US)

(72) Inventors: Geeta Rana, Sugar Land, TX (US); Jeremy Moloney, Katy, TX (US)

(21) Appl. No.: 18/604,780

(22) Filed: Mar. 14, 2024

Related U.S. Application Data
(60) Provisional application No. 63/490,257, filed on Mar. 15, 2023.

(51) Int. Cl. C09K 8/54

(52) U.S. Cl. CPC C09K 8/54; C09K 2208/32

(57) ABSTRACT

Methods for inhibiting corrosion by contacting a surface in an oil-field system with a composition comprising a soy-based corrosion inhibitor are provided.

### CROSS REFERENCE TO RELATED APPLICATIONS

This application claims priority under 35 U.S.C. § 119 to provisional patent application U.S. Ser. No. 63/490,257, filed Mar. 15, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to corrosion-inhibiting compositions and methods for improved corrosion inhibition of metal surfaces in oil and gas application using soy based products to replace conventional corrosion inhibitors.

### BACKGROUND

Corrosion remains a significant challenge in the oil and gas industry and are most often caused by salts and/or other dissolved solids, liquids, or gases that cause, accelerate, or promote corrosion of surfaces such as metal surfaces. Controlling internal corrosion is a key problem encountered in flowlines and pipelines made from metal, namely carbon steel. Examples of corrodents include carbon dioxide, oxygen, sodium chloride, calcium chloride, and sulfur dioxide. Corrosion negatively impacts metal containments such as metal pipelines, tanks, and/or other metal equipment or devices that contact aqueous liquid sources before, during, or after injection or production.

Most operators in the oil and gas extraction and processing industry employ corrosion inhibitors to reduce internal corrosion in metal containments which are contacted by aqueous liquids containing corrodents. Corrodents are found in injectates, produced water, connate (native water present in subterranean formations along with the hydrocarbon), and hydrocarbon liquids and solids. Corrosion inhibitors are added to the liquids and dissolved gases which come into contact with metal surfaces where they act to prevent, retard, delay, reverse, and/or otherwise inhibit the corrosion of metal surfaces such as carbon-steel metal surfaces. Corrosion inhibitors can include, for example, aliphatic and aromatic amines, amine salts of acids, heterocyclic amines, alkenyl succinic acid, triazoles, and the like.

Corrosion inhibitors are beneficial in that they extend the lifespan of metal surfaces, as well as permit the use of carbon steel components rather than more expensive metals, such as nickel, cobalt, and chromium alloys or other materials more expensive than carbon steel and/or which inherently entail other disadvantages in suitability for the purpose of liquid or gas containment.

It is an object of this disclosure to provide soy-based corrosion-inhibitors and methods for corrosion inhibition of metal surfaces that improve beyond the corrosion inhibition capability of existing corrosion inhibitors. It is a particular object of the disclosure to provide soy-based products to provide an environmentally friendly corrosion inhibition composition and methods of corrosion inhibition.

Other objects, embodiments advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide compositions and methods for inhibiting corrosion in oilfield systems, namely pipelines, containing oxygen.

According to some aspects of the present disclosure, corrosion-inhibiting compositions comprise soy-based corrosion inhibitors. Methods of inhibiting corrosion comprise: adding a corrosive inhibiting effective amount of a composition comprising a soy-based corrosion inhibitor to an oil-field system having at least one surface and inhibiting corrosion of the at least one surface, wherein the soy-based corrosion inhibitor comprises at least one of (i) soy oil, (ii) soy fatty acid ester, epoxidized and non-epoxidized, and (iii) an epoxidized soy fatty oil surfactant, with the structure of Formula I or II

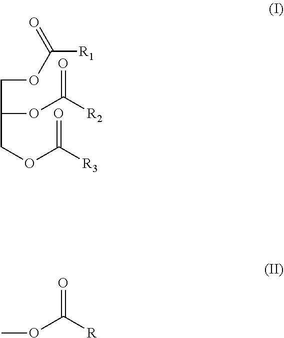

wherein: (iₐ) for the soy oil with the structure of Formula I, R₁, R₂ and R₃ are independently selected C1-C23 hydrocarbon chains having 0 to 5 unsaturated C═C bonds wherein at least 1 bond is hydrolyzed to —OH in at least one of R₁, R₂ and R₃, (i_{b}) for the soy oil with the structure of Formula II, R is a C1-C23 hydrocarbon chain having 1 to 5 unsaturated C═C bonds wherein at least 1 bond is hydrolyzed to —OH, (iiₐ) for the soy fatty acid ester with the structure of Formula I, R₁, R₂ and R₃ are independently selected C1-C23 hydrocarbon chains having 0 to 5 epoxides, and wherein at least 1 epoxide is present in at least one of R₁, R₂ and R₃, (ii_{b}) for the soy fatty acid ester with the structure of Formula II, R is a C1-C23 hydrocarbon chain having 1 to 5 epoxides, (ii_{c}) for the soy fatty acid ester with the structure of Formula I, R₁, R₂ and R₃ are independently selected C1-C23 hydrocarbon chains having 0 to 5 epoxides, and wherein at least 1 epoxide is opened with an acrylic acid in at least one of R₁, R₂ and R₃, (ii_{d}) for the soy fatty acid ester with the structure of Formula II, R is a C1-C23 hydrocarbon chain having 1 to 5 epoxides, and wherein at least 1 epoxide is opened with an acrylic acid, (iiiₐ) for the epoxidized soy fatty oil surfactant with the structure of Formula I, R₁, R₂ and R₃ are independently selected C1-C23 hydrocarbon chains having 0 to 5 epoxides and wherein at least 1 epoxide is opened with an amine in at least one of R₁, R₂ and R₃, or (iii_{b}) for the epoxidized soy fatty oil surfactant with the structure of Formula II, R is a C1-C23 hydrocarbon chain having 1 to 5 epoxides and wherein at least 1 epoxide is opened with an amine.

According to additional aspects of the present disclosure, methods of inhibiting corrosion comprise adding a corrosive inhibiting effective amount of a composition comprising a soy-based corrosion inhibitor, a synergist and/or additional corrosion inhibitor, to an oil-field system having at least one surface and inhibiting corrosion of the at least one surface.

According to additional aspects of the present disclosure, the methods of inhibiting corrosion including adding at least one additional component to the composition wherein the additional component is selected from the group consisting of synergist, additional corrosion inhibitors, solvents, pH modifiers, surfactants, hydrate inhibitors, scale inhibitors, biocides, salt substitutes, relative permeability modifiers, sulfide scavengers, breakers, asphaltene inhibitors, paraffin inhibitors, metal complexing agents, emulsifiers, demulsifiers, iron control agents, friction reducers, drag reducing agents, flow improvers, viscosity reducers, and combinations thereof.

According to additional aspects of the present disclosure, the methods of inhibiting corrosion including adding the composition to the oilfield system manually or automatically in either a batch or continuous manner. In additional aspects, the oil-field system is a well, pipeline, fuel storage and/or transportation tanks, and/or fuel distribution system, and/or wherein the oil-field system comprises liquid that is crude oil, petroleum fuel or oil, a condensate, a distillate or cooling water. In additional aspects, the oil-field system comprises one or more corrodents selected from the group consisting of oxygen, hydrogen sulfide, hydrogen chloride, carbon dioxide, sodium chloride, calcium chloride, sulfur dioxide, and combinations thereof. In additional aspects, the treated surface comprises a metal surface. In additional aspects, the oil-field system is at a temperature of about 0° C. to about 100° C. In additional aspects, the composition reduces corrosion of the surface compared to a corrosive environment that does not contain the soy-based corrosion inhibitor. In embodiments, wherein the corrosion reduction is from about 70% to about 95% for a surface comprising metal.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Several embodiments in which the present disclosure can be practiced are illustrated and described in detail, wherein like reference characters represent like components throughout the several views.

FIG. 1 shows a plot of corrosion rate in mils penetration per year (also referred to as milli-inches per year) (mpy) as a function of time for soy fatty oil surfactant compositions compared to control compositions evaluated over 21 hours for corrosion inhibition as described in Example 1.

FIG. 2 shows a plot of corrosion rate in mpy as a function of time for soy oil compositions, soy fatty acid ester, epoxidized and non-epoxidized (AESME) compositions, and epoxidized soy fatty oil surfactant compositions compared to control compositions evaluated over 21 hours for corrosion inhibition as described in Example 1.

FIG. 3 shows an additional plot of corrosion rate in mpy as a function of time for soy oil compositions, soy fatty acid ester, epoxidized and non-epoxidized (AESME) compositions, and epoxidized soy fatty oil surfactant compositions compared to control compositions evaluated over 21 hours for corrosion inhibition as described in Example 1.

FIG. 4 shows a plot of corrosion rate in mpy as a function of time for soy oil compositions and epoxidized soy fatty oil surfactant compositions compared to control compositions evaluated over 21 hours for corrosion inhibition as described in Example 1.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has beneficially been found that various soy-based products provide effective corrosion inhibition and are more environmentally acceptable compositions.

### Definitions

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, “consisting of” and “consisting essentially of”, the embodiments or elements presented herein, whether explicitly set forth or not.

The methods of the present disclosure may comprise, consist essentially of, or consist of the components and ingredients of the present disclosure as well as other ingredients described herein. As used herein, “consisting essentially of” means that the methods may include additional steps, components or ingredients, but only if the additional steps, components or ingredients do not materially alter the basic and novel characteristics of the claimed methods.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyls can include straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Commonly used alkyl groups include, but are not limited to, methyl, ethyl, n-propyl, isopropyl, n-butyl, iso-butyl, secondary-butyl, and tertiary-butyl.

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

As used herein, the term “containment” or “metal containment” includes any metal surface or portion thereof that is in contact with liquids in an oil-field system containing corrodent(s). In embodiments the containment is in fluid communication with one or more devices or apparatuses, including other containments. In embodiments the containment is a pipe. In embodiments the containment is a tank. In embodiments, the metal is steel. In embodiments, the steel is carbon steel. In embodiments, the carbon steel is stainless steel.

As used herein, the term “corrodent” refers to one or more salts and/or other dissolved solids, liquids, or gasses that cause, accelerate, or promote corrosion. Non-limiting examples of corrodents are oxygen, hydrogen sulfide, hydrogen chloride, carbon dioxide, sodium chloride, calcium chloride, sulfur dioxide, and combinations thereof. In exemplary embodiments, corrodents are capable of corroding a carbon steel at a rate of at least about 100 milli-inches per year (mpy).

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

The term “generally” encompasses both “about” and “substantially.”

The term “inhibiting” as referred to herein includes both inhibiting and preventing corrosion on a surface or within a system, namely an oil-field system.

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “produced water” means a water source that flows from a subterranean formation in a hydrocarbon recovery process such as hydraulic fracturing or tertiary oil recovery, further wherein the water source includes one or more hydrocarbons, one or more dissolved solids, or a combination thereof.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. Further, an alkylene group in the chain can be replaced with an ether, an amine, an amide, a carbonyl, an ester, a cycloalkyl, or a heterocyclo functional group. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Soy-Based Corrosion Inhibitors

Triglycerides have the general formula

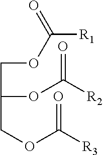

wherein R₁, R₂ and R₃ are independently selected C1-C23, preferably C11-21, hydrocarbon chains having 0 to 5, preferably 0 to 3, or more preferably 1 to 2, unsaturated C═C bonds. A glyceride is a monomer having the general formula

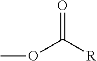

wherein R is a C1-C23, preferably C11-21, hydrocarbon chain having 0 to 5, preferably 0 to 3, or more preferably 1 to 2, unsaturated C═C bonds.

Soybean oil is a triol or a triglyceride having the following structure:

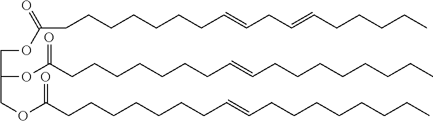 [SMILES: CCCCC/C=C/C/C=C/CCCCCCCC(=O)OCC(COC(=O)CCCCCCC/C=C/CCCCCCCC)OC(=O)CCCCCCC/C=C/CCCCCCCC]

Monomers derived from soybean oil include the following structures:

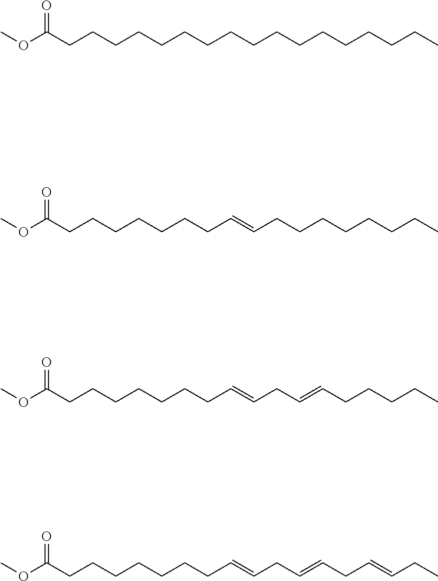

Various structures can be derived from soybean oils, and are referred to herein as soy derived. Methods according to the description beneficially provide an environmentally friendly alternative to existing corrosion inhibitors in providing soy-based corrosion inhibitors. Soy-based corrosion inhibitors for use in an oil-field systems include (i) soy oils, (ii) soy fatty esters, epoxidized and non-epoxidized, and (iii) epoxidized soy fatty oil surfactants, having the general structure of Formula I (polymer) or Formula II (monomer):

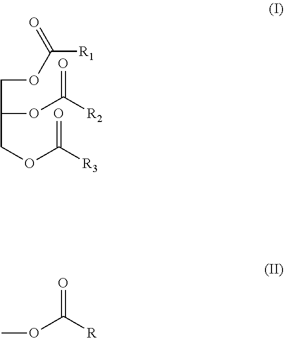

wherein:
(iₐ) for the soy oil with the structure of Formula I, R₁, R₂ and R₃ are independently selected C1-C23 hydrocarbon chains having 0 to 5 unsaturated C═C bonds wherein at least 1 bond is hydrolyzed to —OH in at least one of R₁, R₂ and R₃,
(i_{b}) for the soy oil with the structure of Formula II, R is a C1-C23 hydrocarbon chain having 1 to 5 unsaturated C═C bonds wherein at least 1 bond is hydrolyzed to —OH,
(iiₐ) for the soy fatty acid ester with the structure of Formula I, R₁, R₂ and R₃ are independently selected C1-C23 hydrocarbon chains having 0 to 5 epoxides, and wherein at least 1 epoxide is present in at least one of R₁, R₂ and R₃,
(ii_{b}) for the soy fatty acid ester with the structure of Formula II, R is a C1-C23 hydrocarbon chain having 1 to 5 epoxides,
(ii_{c}) for the soy fatty acid ester with the structure of Formula I, R₁, R₂ and R₃ are independently selected C1-C23 hydrocarbon chains having 0 to 5 epoxides, and wherein at least 1 epoxide is opened with an acrylic acid in at least one of R₁, R₂ and R₃,
(iiₐ) for the soy fatty acid ester with the structure of Formula II, R is a C1-C23 hydrocarbon chain having 1 to 5 epoxides, and wherein at least 1 epoxide is opened with an acrylic acid,
(iiiₐ) for the epoxidized soy fatty oil surfactant with the structure of Formula I, R₁, R₂and R₃ are independently selected C1-C23 hydrocarbon chains having 0 to 5 epoxides and wherein at least 1 epoxide is opened with an amine in at least one of R₁, R₂ and R₃, or
(iii_{b}) for the epoxidized soy fatty oil surfactant with the structure of Formula II, R is a C1-C23 hydrocarbon chain having 1 to 5 epoxides and wherein at least 1 epoxide is opened with an amine.

In some embodiments, the soy-based corrosion inhibitor(s) is included in a composition at an amount of at least about 10 wt-% to about 40 wt-%, about 1 wt-% to about 20 wt-%, about 1 wt-% to about 15 wt-%, or about 5 wt-% to about 15 wt-%. In addition, without being limited according to the disclosure, all ranges recited are inclusive of the numbers defining the range and include each integer within the defined range.

### Soy Oils

The soy oil corrosion inhibitors have the general structure of Formula I (polymer) or Formula II (monomer) wherein: (a) R₁, R₂ and R₃ are independently selected C1-C23 hydrocarbon chains having 0 to 5 unsaturated C═C bonds wherein at least 1 bond is hydrolyzed to —OH in at least one of R₁, R₂ and R₃, or (b) R is a C1-C23 hydrocarbon chain having 1 to 5 unsaturated C═C bonds wherein at least 1 bond is hydrolyzed to —OH.

In further embodiments, the soy oil corrosion inhibitors have the general structure of Formula I (polymer) or Formula II (monomer) wherein: (a) R₁, R₂ and R₃ are independently selected C1-C23 or C11-C21 hydrocarbon chains having 0 to 5, 1 to 5, 2 to 5, 3 to 5, or 4 to 5 unsaturated C═C bonds wherein at least 1 bond is hydrolyzed to-OH in at least one of R₁, R₂ and R₃, or (b) R is a C1-C23 or C11-C21 hydrocarbon chain having 1 to 5, 2 to 5, 3 to 5, or 4 to 5 unsaturated C═C bonds wherein at least 1 bond is hydrolyzed to —OH.

In further embodiments, the soy oil corrosion inhibitors have the general structure of Formula I (polymer) or Formula II (monomer) wherein: (a) R₁, R₂ and R₃ are independently selected C1-C23 hydrocarbon chains having 0 to 3 unsaturated C═C bonds wherein at least 1 bond is hydrolyzed to —OH in at least one of R₁, R₂ and R₃, or (b) R is a C1-C23 hydrocarbon chain having 1 to 3 unsaturated C═C bonds wherein at least 1 bond is hydrolyzed to —OH.

In still further embodiments, the soy oil corrosion inhibitors have the general structure of Formula I (polymer) or Formula II (monomer) wherein: (a) R₁, R₂ and R₃ are independently selected C11-C22 hydrocarbon chains having 0 to 3 unsaturated C═C bonds wherein at least 1 bond is hydrolyzed to —OH in at least one of R₁, R₂ and R₃, or (b) R is a C11-C22 hydrocarbon chain having 1 to 3 unsaturated C═C bonds wherein at least 1 bond is hydrolyzed to —OH.

In still further embodiments, the soy oil corrosion inhibitors have at least 20%, at least 40%, at least 60%, at least 80%, or 100% of the unsaturated C═C bonds hydrolyzed to —OH.

Hydrolysis of the C═C bonds in the soy corrosion inhibitors to add an —OH group can take place by various pathways, including conventional hydrolysis of an alkene to form an alcohol. Alternatively, the alkenes in the soy oils can be first epoxidized and then the epoxide rinks opened via hydrolysis.

Soy oil corrosion inhibitors can have the following exemplary formulae:

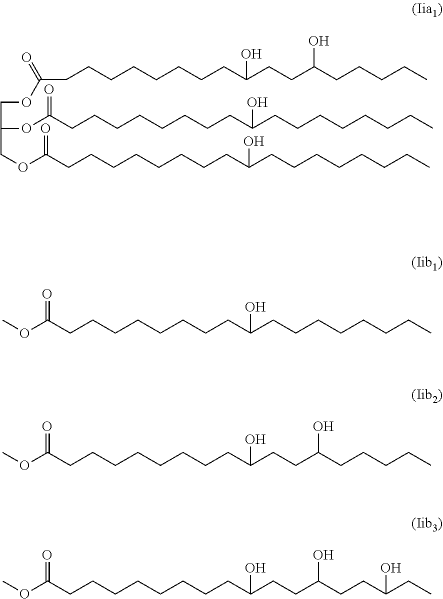

### Soy Fatty Esters

The soy fatty ester, epoxidized and non-epoxidized, corrosion inhibitors have the general structure of Formula I (polymer) or Formula II (monomer) wherein: (a) R₁, R₂ and R₃ are independently selected C1-C23 hydrocarbon chains having 0 to 5 epoxides, and wherein at least 1 epoxide is present in at least one of R₁, R₂ and R₃, (b) R is a C1-C23 hydrocarbon chain having 1 to 5 epoxides, (c) R₁, R₂ and R₃ are independently selected C1-C23 hydrocarbon chains having 0 to 5 epoxides, and wherein at least 1 epoxide is opened with an acrylic acid in at least one of R₁, R₂ and R₃, or (d) R is a C1-C23 hydrocarbon chain having 1 to 5 epoxides, and wherein at least 1 epoxide is opened with an acrylic acid.

In further embodiments, the soy fatty ester, epoxidized and non-epoxidized, corrosion inhibitors have the general structure of Formula I (polymer) or Formula II (monomer) wherein: (a) R₁, R₂ and R₃ are independently selected C1-C23 or C11-C21 hydrocarbon chains having 0 to 5, 1 to 5, 2 to 5, 3 to 5, or 4 to 5 epoxides, and wherein at least 1 epoxide is present in at least one of R₁, R₂ and R₃, (b) R is a C1-C23 or C11-C21 hydrocarbon chain having 1 to 5, 2 to 5, 3 to 5, or 4 to 5 epoxides, (c) R₁, R₂ and R₃ are independently selected C1-C23 or C11-C21 hydrocarbon chains having 0 to 5, 1 to 5, 2 to 5, 3 to 5, or 4 to 5 epoxides, and wherein at least 1 epoxide is opened with an acrylic acid in at least one of R₁, R₂ and R₃, or (d) R is a C1-C23 or C11-C21 hydrocarbon chain having 1 to 5, 2 to 5, 3 to 5, or 4 to 5 epoxides, and wherein at least 1 epoxide is opened with an acrylic acid.

In further embodiments, the soy fatty ester, epoxidized and non-epoxidized, corrosion inhibitors have the general structure of Formula I (polymer) or Formula II (monomer) wherein: (a) R₁, R₂ and R₃ are independently selected C1-C23 hydrocarbon chains having 0 to 3 epoxides, and wherein at least 1 epoxide is present in at least one of R₁, R₂ and R₃, (b) R is a C1-C23 hydrocarbon chain having 1 to 3 epoxides, (c) R₁, R₂ and R₃ are independently selected C1-C23 hydrocarbon chains having 0 to 3 epoxides, and wherein at least 1 epoxide is opened with an acrylic acid in at least one of R₁, R₂ and R₃, or (d) R is a C1-C23 hydrocarbon chain having 1 to 3 epoxides, and wherein at least 1 epoxide is opened with an acrylic acid.

In still further embodiments, the soy fatty ester, epoxidized and non-epoxidized, corrosion inhibitors have the general structure of Formula I (polymer) or Formula II (monomer) wherein: (a) R₁, R₂ and R₃ are independently selected C11-C21 hydrocarbon chains having 0 to 3 epoxides, and wherein at least 1 epoxide is present in at least one of R₁, R₂ and R₃, (b) R is a C11-C21 hydrocarbon chain having 1 to 3 epoxides, (c) R₁, R₂ and R₃ are independently selected C11-C21 hydrocarbon chains having 0 to 3 epoxides, and wherein at least 1 epoxide is opened with an acrylic acid in at least one of R₁, R₂ and R₃, or (d) R is a C11-C21 hydrocarbon chain having 1 to 3 epoxides, and wherein at least 1 epoxide is opened with an acrylic acid.

Epoxidized soy fatty acid ester corrosion inhibitors can have the following exemplary formulae:

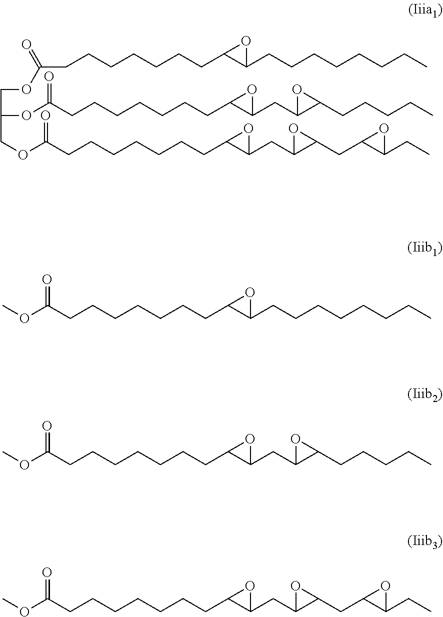

Soy fatty acid ester, epoxidized and non-epoxidized, corrosion inhibitors can have the following exemplary formulae:

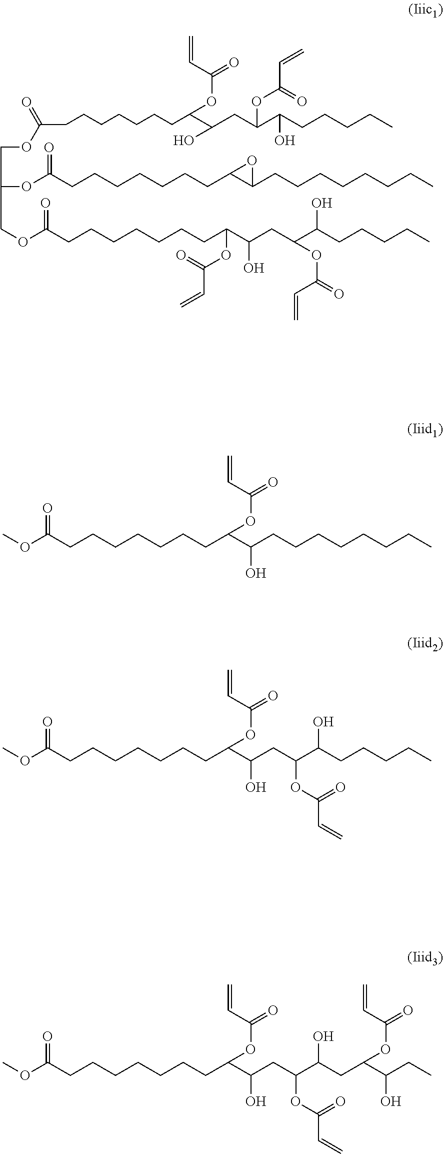

In still further embodiments, the soy fatty acid ester corrosion inhibitors have at least 20%, at least 40%, at least 60%, at least 80%, or 100% of the epoxides opened with the acrylic acid.

### Epoxidized Soy Fatty Oil Surfactant

The epoxidized soy fatty oil surfactant corrosion inhibitors have the general structure of Formula I (polymer) or Formula II (monomer) wherein: (a) R₁, R₂ and R₃ are independently selected C1-C23 hydrocarbon chains having 0 to 5 epoxides and wherein at least 1 epoxide is opened with an amine in at least one of R₁, R₂ and R₃, or (b) R is a C1-C23 hydrocarbon chain having 1 to 5 epoxides and wherein at least 1 epoxide is opened with an amine.

In further embodiments, the epoxidized soy fatty oil surfactant corrosion inhibitors have the general structure of Formula I (polymer) or Formula II (monomer) wherein: (a) R₁, R₂ and R₃ are independently selected C1-C23 or C11-C21 hydrocarbon chains having 0 to 5, 1 to 5, 2 to 5, 3 to 5, or 4 to 5 epoxides and wherein at least 1 epoxide is opened with an amine in at least one of R₁, R₂ and R₃, or (b) R is a C1-C23 or C11-C21 hydrocarbon chain having 1 to 5, 2 to 5, 3 to 5, or 4 to 5 epoxides and wherein at least 1 epoxide is opened with an amine.

In further embodiments, the epoxidized soy fatty oil surfactant corrosion inhibitors have the general structure of Formula I (polymer) or Formula II (monomer) wherein: (a) R₁, R₂ and R₃ are independently selected C1-C23 hydrocarbon chains having 0 to 3 epoxides and wherein at least 1 epoxide is opened with an amine in at least one of R₁, R₂ and R₃, or (b) R is a C1-C23 hydrocarbon chain having 1 to 3 epoxides and wherein at least 1 epoxide is opened with an amine.

In still further embodiments, the epoxidized soy fatty oil surfactant corrosion inhibitors have the general structure of Formula I (polymer) or Formula II (monomer) wherein: (a) R₁, R₂ and R₃ are independently selected C11-C21 hydrocarbon chains having 0 to 3 epoxides and wherein at least 1 epoxide is opened with an amine in at least one of R₁, R₂and R₃, or (b) R is a C11-C21 hydrocarbon chain having 1 to 3 epoxides and wherein at least 1 epoxide is opened with an amine.

In still further embodiments, the epoxidized soy fatty oil surfactant has at least 20%, at least 40%, at least 60%, at least 80%, or 100%of the epoxides opened with the amine.

As referred to herein, the amine can include an —NH₂ group. Amines can also further include RNH₂ or R₂NH, wherein R is independently a C1-C24 alkyl chain or (CH₂)ₓ—)OH, wherein x is 1-10.

Epoxidized soy fatty oil surfactant corrosion inhibitors can have the following exemplary formulae:

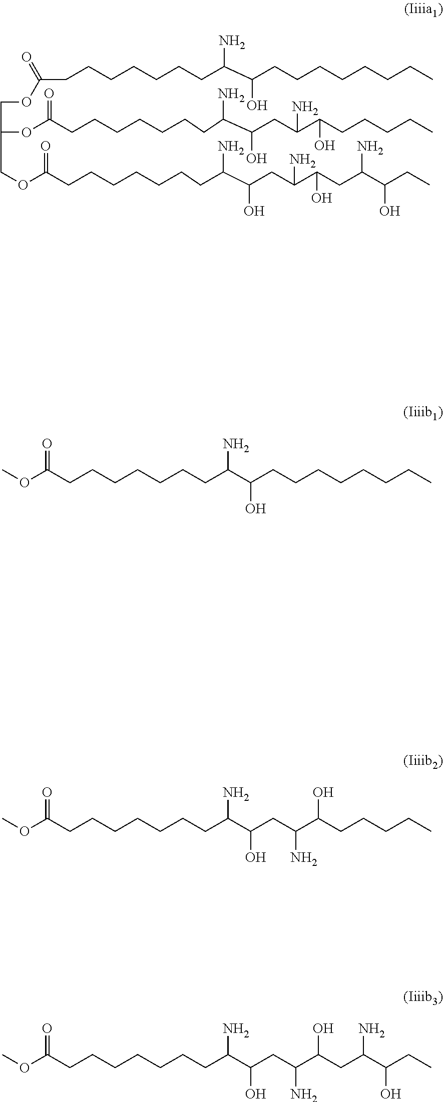

### Solvent

The soy-based corrosion inhibitors can be combined with or delivered with a solvent. In some embodiments more than one solvent is included in the compositions. An exemplary solvent is water, an organic solvent and/or aromatic solvent. An exemplary solvent is water.

Further exemplary organic solvents can include an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, glycols and derivatives (ethylene glycol, methylene glycol, 1,2-propylene glycol, 1,3-propylene glycol, diethyleneglycol monomethyl ether, ethylene glycol monobutyl ether, ethylene glycol dibutyl ether, etc.), pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

In some embodiments, an alcohol solvent is used, including straight chain or branched aliphatic such as methanol, ethanol, propanol, isopropanol, butanol, 2-ethylhexanol, hexanol, octanol, decanol, 2-butoxyethanol, etc.

In some embodiments, the composition comprises one or more solvents selected from the group consisting of isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or any combination thereof.

Exemplary aromatic solvents comprise aromatic hydrocarbons such as toluene, xylene, heavy aromatic naphtha, or a combination thereof. Preferably, the aromatic solvent comprises heavy aromatic naphtha or xylene. In any of the embodiments described the aromatic solvent(s) is preferably combined with water.

In some embodiments, the solvent(s) is included in a composition with the soy-based corrosion inhibitors at an amount of at least about 20 wt-% to about 90 wt-%, about 30 wt-% to about 90 wt-%, about 40 wt-% to about 80 wt-%, about 45 wt-% to about 80 wt-%, or about 50 wt-% to about 80 wt-%. In addition, without being limited according to the disclosure, all ranges recited are inclusive of the numbers defining the range and include each integer within the defined range.

### Synergist

The soy-based corrosion inhibitors can be combined with or delivered with a synergist. An exemplary synergist class includes mercaptan corrosion inhibitors. Mercaptans are a type of organic thiol molecules and can create a stronger passivation layer on the metal surface to increase persistency of the protective film for corrosion inhibition. In most examples, the sulfur based component consists of a primary thio/mercaptan (e.g., 2-mercaptoethanol or mercaptoacetic acid). Mercaptans are a type of organic sulfur compounds, which include mercaptoalkyl alcohol, mercaptoacetic acid, tert-butyl mercaptan, or a combination thereof. A preferred synergist is a mercaptoalkyl alcohol comprising 2-mercaptoethanol.

Additional exemplary synergist class includes amines such as thiol-amines as disclosed in U.S. Pat. No. 11,242,480, which is incorporated herein by reference in its entirety. These thiol-amines include a class of anti-corrosion compounds having the formula:

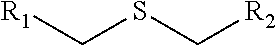

wherein: each R₁ is independently —CH₂OH and —C(O)OH; and R₂ is

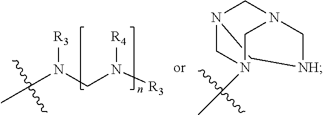

Each R₃ is independently hydrogen or R₅, or both R₃ together form a ring via linker having the formula

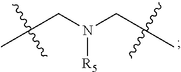

Each R₄ is independently hydrogen or R₅;
R₅ is —CH₂SC₂H₅R₁; and
n is an integer from 0 to 3.

In some embodiments, the synergist is included in a composition with the soy-based corrosion inhibitors at an amount of at least about 0.1 wt-% to about 20 wt-%, about 1 wt-% to about 20 wt-%, about 5 wt-% to about 20 wt-%, about 5 wt-% to about 15 wt-%, or about 5 wt-% to about 10 wt-%. In addition, without being limited according to the disclosure, all ranges recited are inclusive of the numbers defining the range and include each integer within the defined range.

### Additional Functional Ingredients

The soy-based corrosion inhibitors can further be combined with various additional functional components suitable for uses disclosed herein. In some embodiments, the compositions including the soy-based corrosion inhibitor and solvent make up a large amount, or even substantially all of the total weight of the compositions. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in the use and/or concentrate compositions described herein provides a beneficial property in a particular use.

In some embodiments, the compositions may include synergist, additional corrosion inhibitors, solvents, pH modifiers, surfactants, hydrate inhibitors, scale inhibitors, biocides, salt substitutes, relative permeability modifiers, sulfide scavengers, breakers, asphaltene inhibitors, paraffin inhibitors, metal complexing agents (chelants), emulsifiers, demulsifiers, iron control agents, friction reducers, drag reducing agents, flow improvers, viscosity reducers, and the like. Exemplary types of the various additional functional ingredients is included in U.S. Pat. No. 11,242,480, which is incorporated by reference in its disclosure of the various listings of additional functional ingredients.

In an exemplary embodiment, the soy-based corrosion inhibitor is combined with at least one of a synergist, additional corrosion inhibitor, and solvent. In further embodiments the soy-based corrosion inhibitor is combined with from about 40 wt-% to about 90 wt-% of at least one of a synergist, additional corrosion inhibitor(s), and solvent. In still further embodiments, the synergist comprises from about 1 wt-% to about 10 wt-%, the additional corrosion inhibitors comprise from about 5 wt-% to about 20 wt-%, and/or the solvent comprises from about 50 wt-% to about 90 wt-% of the composition comprising the soy-based corrosion inhibitor. In still further embodiments, the synergist comprises from about 5 wt-% to about 10 wt-%, the additional corrosion inhibitors comprise from about 5 wt-% to about 12 wt-%, and/or the solvent comprises from about 70 wt-% to about 90 wt-% of the composition comprising the soy-based corrosion inhibitor.

According to embodiments of the disclosure, the combination of any additional functional ingredients may be provided in a composition in the amount from about 0 wt-% and about 90 wt-%, from about 5 wt-% and about 90 wt-%, or from about 10 wt-% and about 90 wt-%. In addition, without being limited according to the disclosure, all ranges recited are inclusive of the numbers defining the range and include each integer within the defined range.

Typically, the compositions are stable to ambient conditions. In some embodiments, the composition is stable at room temperature for at least 6 months, when stored in a sealed container. For example, the composition can be stable at room temperature for at least 9 months, e.g., at least 12 months, at least 18 months, or at least 24 months, when stored in a sealed container. As used herein, the phrase “sealed container” refers to a container constructed of compatible materials (e.g., glass or non-gas permeable plastic) that has been sealed shut. The sealed container can be any non-gas permeable container, where water or volatile materials cannot escape when sealed with a lid that limits evaporation. The non-gas permeable container also limits O₂ or CO₂ ingress into the composition at storage temperatures. Typical examples would be glass jars or bottles with tight-sealing lids, or non-gas permeable plastic bottles with tight-sealing lids.

### METHODS OF USE

The corrosion-inhibiting compositions are provided to a system in need of effective corrosion control. The methods are suitable for controlling both general and localized corrosion. In some embodiments, the methods and compositions may be effective against pitting inhibition.

The soy-based corrosion inhibitors can be provided in a single composition to an oil-field system or can be combined with other components, such as solvents, synergists, additional corrosion inhibitors, and the like. In referring to compositions, the scope of the methods of use disclosure also includes combining more than one input (i.e. composition) for the treatment of an oil-field system.

The methods of use include adding a corrosive inhibiting effective amount of a composition comprising a soy-based corrosion inhibitor to an oil-field system having at least one surface and inhibiting corrosion of the at least one surface. Beneficially, the composition reduces corrosion of a surface compared to a corrosive environment that does not contain the soy-based corrosion inhibitor. In embodiments, the corrosion reduction (i.e. inhibition efficiency) is from about 70% to about 95% for a surface comprising metal.

The methods apply the soy-based corrosion inhibitors to a system in need of preventing, reducing or mitigating corrosion. Beneficially, for the corrosion inhibition both localized and generalized corrosion are reduced, as measured by mils penetration per year or milli-inch (one thousandth of an inch) (MPY). MPY is used as an estimated general corrosion rate. The MPY is calculated from the following equation:

$$MPY = ( Δ M [ g ] \cdot C ) / ( ρ [ \frac{g}{{cm}^{2}} ] \cdot A [ {in}^{2} ] \cdot t [ hr ] )$$

where ΔM is the mass loss of the coupon at the end of the test in grams, C is a constant equal to 534000, ρ is the density of the coupon in g/cm², A is the surface area of the coupon in cm², and t is the exposure time in hours.

The method comprises adding the composition containing the soy-based corrosion inhibitors in a corrosive inhibiting effective amount. The dosage amounts of the compositions described herein to be added to oil-field system can be tailored by one skilled in the art based on factors for each system, including, for example, content of fluid, volume of the fluid, surface area of the system, temperatures, pH, and CO₂ content. In embodiments, an effective amount of the composition is from about 1 ppm to about 500 ppm. In embodiments, an effective amount of the composition is from about from about 1 ppm to about 250 ppm, or preferably from about 1 ppm to about 200 ppm, based on the total volume of the system.

The oil-field systems include oil or gas pipelines and refineries, including for example, well, pipeline, fuel storage and/or transportation tanks, fuel distribution system.

The system includes a fluid to which the composition is added. A fluid to which the compositions can be introduced can be a hydrocarbon fluid or gas, produced water, or combination thereof. As referred to herein, hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof. In many embodiments, hydrocarbon fluids comprise refined hydrocarbon product. The liquid can also be a heavy brine.

The fluid can be contained in and/or exposed to many different types of apparatuses. In embodiments, the fluid is contained in a containment, such as an oil or gas pipeline. Additionally, the fluid can be contained in refineries, such as surfaces used in the recovery, transportation, refining and/or storage of hydrocarbon fluids or gases.

The oil-field systems comprise a surface in need of corrosion inhibition. Exemplary surfaces can include separation vessels, dehydration units, gas lines, oil and/or gas pipelines, or other part of an oil and/or gas refinery. Similarly, the fluid can be contained in and/or exposed to an apparatus used in oil extraction and/or production, such as a wellhead. The apparatus can be part of a coal-fired power plant. The apparatus can be a scrubber (e.g., a wet flue gas desulfurizer, a spray dry absorber, a dry sorbent injector, a spray tower, a contact or bubble tower, or the like). The apparatus can be a cargo vessel, a storage vessel, a holding tank, or a pipeline connecting the tanks, vessels, or processing units.

The system comprises a metal surface subject to corrosion. In embodiments the surfaces can include a variety of metal surfaces that are subject to corrosion. The metals can comprise a component selected from the group consisting of mild steel, galvanized steel, carbon steel, aluminum, aluminum alloys, copper, copper nickel alloys, copper zinc alloys, brass, chrome steels, ferritic alloy steels, austenitic stainless steels, precipitation-hardened stainless steels, high nickel content steels, and any combination thereof.

The compositions are applied to fluids in an oil-field system at varying pH ranges. In an embodiment the pH of the fluids will be between about 5 and about 9.

The compositions can be applied to a fluid in an oil-field system at any selected temperature, such as ambient temperature or an elevated temperature. The fluid (e.g., liquid hydrocarbon) can be at a temperature of from about 0° C. to about 100° C.

The compositions can be applied by any appropriate method for ensuring dispersal through the fluid. The compositions can be applied to a fluid using various well-known methods and they can be applied at numerous different locations throughout a given system. For example, the compositions can be injected using mechanical equipment such as chemical injection pumps, piping tees, injection fittings, atomizers, quills, and the like. The compositions can be pumped into an oil and/or gas pipeline using an umbilical line. A capillary injection system can be used to deliver the compounds/compositions to a selected fluid.

The compositions can be added to the system manually or automatically in either a batch or continuous manner to provide the effective amount of the corrosion-inhibiting composition. In some embodiments, the compositions are added to a flow line to provide a corrosive inhibiting effective amount from about 1 to about 500 parts per million (ppm), about 1 ppm to about 250 ppm, or about 1 ppm to about 200 ppm, based on the total volume of the system. In some embodiments, the compositions are added to a flow line to provide a corrosive inhibiting effective amount from at least about 1 ppm, 2 ppm, 5 ppm, 10 ppm, 20 ppm, 50 ppm, 100 ppm, 200 ppm, 250 ppm, or 500 ppm based on the total volume of the system. Each system can have its own dose level requirements, and the effective dose level of the composition to sufficiently reduce the rate of corrosion can vary with the system in which it is used.

The compositions can be added to the system by any suitable means, including for example by injecting the composition into a fluid or gas in contact with the metal surface, pumping the composition onto the metal surface, pouring the composition onto the metal surface, spraying the composition onto the metal surface, wiping the metal surface with the composition, coating the metal surface with the composition, dipping the metal surface in the composition, soaking the metal surface in the composition, or any combination thereof.

### EMBODIMENTS

The present disclosure is further defined by the following numbered embodiments:

[Embodiment 1] A method of inhibiting corrosion comprising: adding a corrosive inhibiting effective amount of a composition comprising a soy-based corrosion inhibitor to an oil-field system having at least one surface and inhibiting corrosion of the at least one surface, wherein the soy-based corrosion inhibitor comprises at least one of (i) soy oil, (ii) soy fatty acid ester, epoxidized and non-epoxidized, and (iii) an epoxidized soy fatty oil surfactant, with the structure of Formula I or II

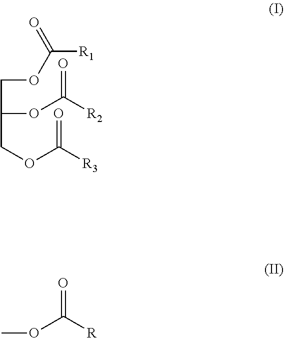

wherein: (iₐ) for the soy oil with the structure of Formula I, R₁, R₂ and R₃ are independently selected C1-C23 hydrocarbon chains having 0 to 5 unsaturated C═C bonds wherein at least 1 bond is hydrolyzed to-OH in at least one of R₁, R₂ and R₃, (i_{b}) for the soy oil with the structure of Formula II, R is a C1-C23 hydrocarbon chain having 1 to 5 unsaturated C═C bonds wherein at least 1 bond is hydrolyzed to —OH, (iiₐ) for the soy fatty acid ester with the structure of Formula I, R₁, R₂ and R₃ are independently selected C1-C23 hydrocarbon chains having 0 to 5 epoxides, and wherein at least 1 epoxide is present in at least one of R₁, R₂ and R₃, (ii_{b}) for the soy fatty acid ester with the structure of Formula II, R is a C1-C23 hydrocarbon chain having 1 to 5 epoxides, (ii_{c}) for the soy fatty acid ester with the structure of Formula I, R₁, R₂ and R₃ are independently selected C1-C23 hydrocarbon chains having 0 to 5 epoxides, and wherein at least 1 epoxide is opened with an acrylic acid in at least one of R₁, R₂ and R₃, (ii_{d}) for the soy fatty acid ester with the structure of Formula II, R is a C1-C23 hydrocarbon chain having 1 to 5 epoxides, and wherein at least 1 epoxide is opened with an acrylic acid, (iiiₐ) for the epoxidized soy fatty oil surfactant with the structure of Formula I, R₁, R₂ and R₃ are independently selected C1-C23 hydrocarbon chains having 0 to 5 epoxides and wherein at least 1 epoxide is opened with an amine in at least one of R₁, R₂ and R₃, or (iii_{b}) for the epoxidized soy fatty oil surfactant with the structure of Formula II, R is a C1-C23 hydrocarbon chain having 1 to 5 epoxides and wherein at least 1 epoxide is opened with an amine.

The method of embodiment 1, wherein the effective amount is from about 1 ppm to about 200 ppm, based on the total volume of the oil-field system.

The method of any one of embodiments 1-2, wherein the soy oil according to Formula I, R₁, R₂ and R₃ are independently selected C11-C21 hydrocarbon chains having 0 to 3 unsaturated C═C bonds wherein at least 1 bond is hydrolyzed to —OH in at least one of R₁, R₂ and R₃, or wherein the soy oil according to Formula II, R is a C11-C21 hydrocarbon chain having 1 to 3 unsaturated C═C bonds wherein at least 1 bond is hydrolyzed to —OH.

The method of embodiment 3, wherein the soy oil has at least 20%, at least 40%, at least 60%, at least 80%, or 100% of the unsaturated C═C bonds hydrolyzed to —OH.

The method of any one of embodiments 1-4, wherein the soy oil corrosion inhibitors has one of the following exemplary formulae:

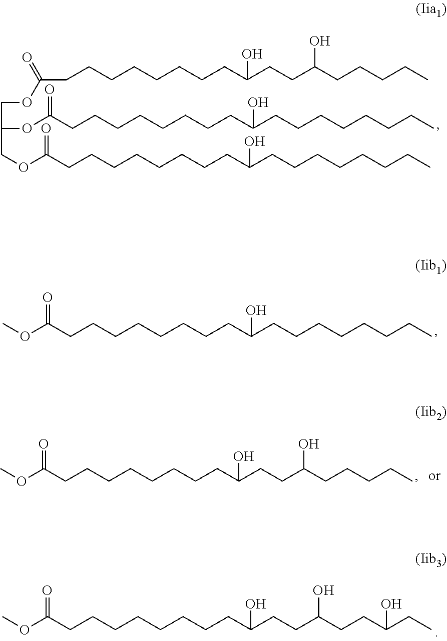

The method of any one of embodiments 1-2, wherein the soy fatty acid ester is according to Formula I, either (i) R₁, R₂ and R₃ are independently selected C11-C21 hydrocarbon chains having 0 to 3 epoxides, wherein at least 1 epoxide is opened with an acrylic acid in at least one of R₁, R₂ and R₃, or (ii) R₁, R₂ and R₃ are independently selected C11-C21 hydrocarbon chains having 0 to 3 epoxides, wherein at least 1 epoxide is present in at least one of R₁, R₂ and R₃, or wherein the soy fatty acid ester is according to Formula II, either (i) R is a C11-C21 hydrocarbon chain having 1 to 3 epoxides, or (ii) R is a C11-C21 hydrocarbon chain having 1 to 3 epoxides and wherein at least 1 epoxide is opened with the acrylic acid.

The method of embodiment 6, wherein the soy fatty acid ester has at least 20%, at least 40%, at least 60%, at least 80%, or 100% of the epoxides opened with the acrylic acid.

The method of any one of embodiments 1-2 or 6-7, wherein the epoxidized soy fatty acid ester corrosion inhibitors has one of the following exemplary formulae:

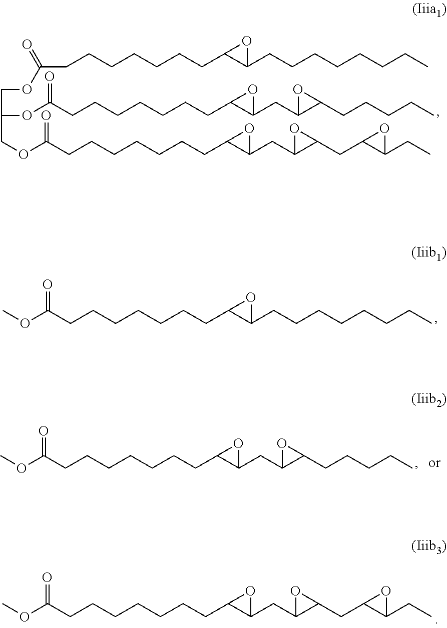

The method of any one of embodiments 1-2 or 6-7. wherein the epoxidized and non-epoxidized soy fatty acid ester corrosion inhibitors has one of the following exemplary formulae:

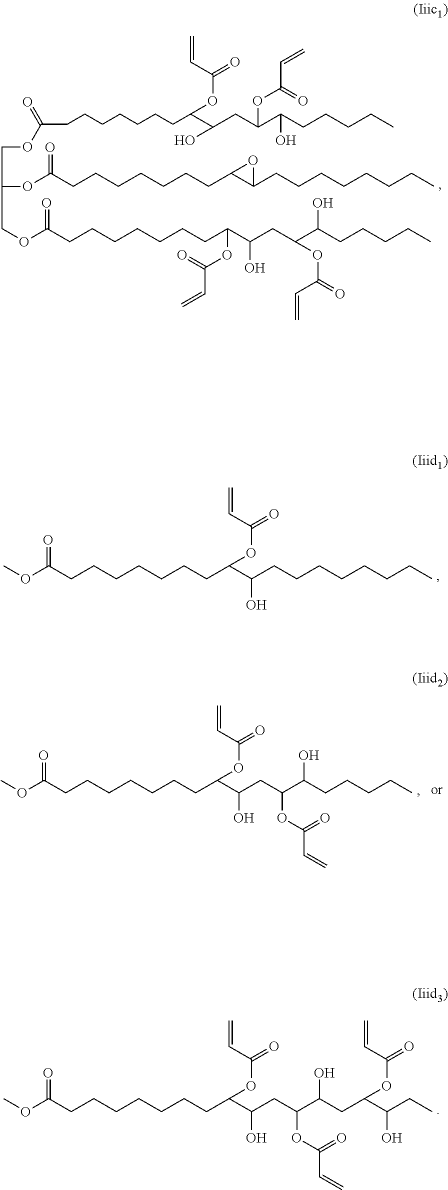

The method of any one of embodiments 1-2, wherein the epoxidized soy fatty oil surfactant is according to Formula I, R₁, R₂ and R₃ are independently selected C11-C21 hydrocarbon chains having 0 to 3 epoxides, wherein at least 1 epoxide is opened with the amine in at least one of R₁, R₂ and R₃, or wherein the epoxidized soy fatty oil surfactant is according to Formula II, R is a C11-C21 hydrocarbon chain having 1 to 3 epoxides and wherein at least 1 epoxide is opened with the amine.

The method of embodiment 10, wherein the epoxidized soy fatty oil surfactant has at least 20%, at least 40%, at least 60%, at least 80%, or 100%of the epoxides opened with the amine.

The method of any one of embodiments 1-2 or 10-11, wherein the epoxidized soy fatty oil surfactant corrosion inhibitors has one of the following exemplary formulae:

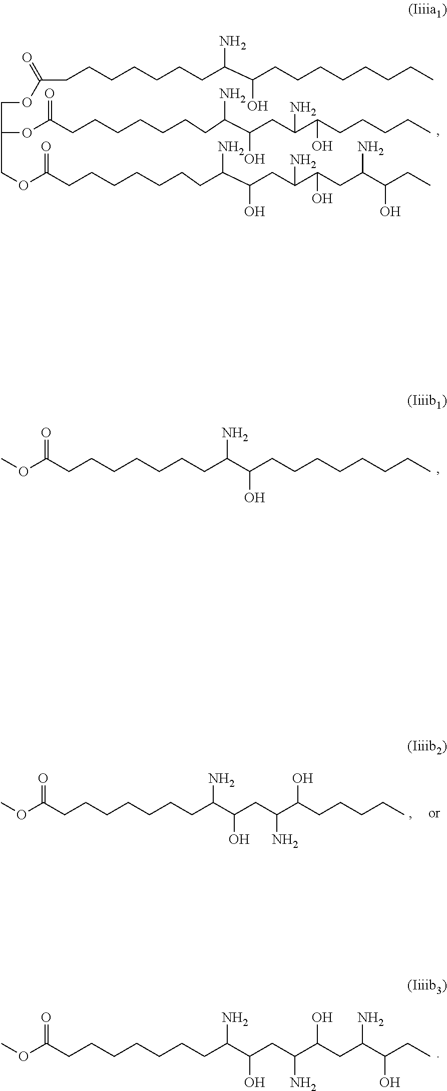

The method of any one of embodiments 1-12, wherein the amine is —NH₂, RNH₂, or R₂NH, wherein R is independently a C1-C24 alkyl chain or (CH₂)ₓ—)OH, wherein x is 1-10.

The method of any one of embodiments 1-13, wherein the composition comprises from about 1 wt-% to about 20 wt-% of the soy-based corrosion inhibitor.

The method of any one of embodiments 1-14, wherein the composition further comprises from about 40 wt-% to about 90 wt-% of at least one of a synergist, additional corrosion inhibitor, and solvent.

The method of any one of embodiments 1-15, wherein the composition further comprises at least one additional component selected from the group consisting of synergist, additional corrosion inhibitors, solvents, pH modifiers, surfactants, hydrate inhibitors, scale inhibitors, biocides, salt substitutes, relative permeability modifiers, sulfide scavengers, breakers, asphaltene inhibitors, paraffin inhibitors, metal complexing agents (chelants), emulsifiers, demulsifiers, iron control agents, friction reducers, drag reducing agents, flow improvers, viscosity reducers, and combinations thereof.

The method of embodiment 16, wherein the synergist comprises a mercaptan corrosion inhibitor.

The method of any one of embodiments 1-17, wherein the composition is added to the oilfield system manually or automatically in either a batch or continuous manner.

The method of any one of embodiments 1-18, wherein the oil-field system is a well, pipeline, fuel storage and/or transportation tanks, and/or fuel distribution system, and/or wherein the oil-field system comprises liquid that is crude oil, petroleum fuel or oil, a condensate, a distillate or cooling water.

The method of any one of embodiments 1-19, wherein the oil-field system comprises one or more corrodents selected from the group consisting of oxygen, hydrogen sulfide, hydrogen chloride, carbon dioxide, sodium chloride, calcium chloride, sulfur dioxide, and combinations thereof.

The method of any one of embodiments 1-20, wherein the surface comprises a metal surface.

The method of any one of embodiments 1-21, wherein the oil-field system is at a temperature of about 0° C. to about 100° C.

The method of any one of embodiments 1-22, wherein the composition reduces corrosion of the surface compared to a corrosive environment that does not contain the soy-based corrosion inhibitor.

The method of embodiment 23, wherein the corrosion reduction (i.e. inhibition efficiency) is from about 70% to about 95% for a surface comprising metal.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Examples were conducted to identify soy-based compositions for corrosion inhibition using bubble cell tests to assess corrosion performance using linear polarization resistance testing.

Soy-based corrosion inhibitors were evaluated for corrosion performance as compared to an imidazoline, benzyl quat, and trimethyl ammonium quat (considered a “green quat”) corrosion inhibitors via a bubble test procedure. The evaluated chemistries are summarized in Table 1.

TABLE 1

| Component | Category | Structure |
|---|---|---|
| Soy-based corrosion | Epoxidized soy fatty | Epoxidized soybean oil (epoxide rings |
| inhibitor | oil surfactant (labeled | opened with amines) |
| | soy fatty oil | |
| | surfactant) | |
| | Soy oil | Transesterification of soy polyol |
| | | 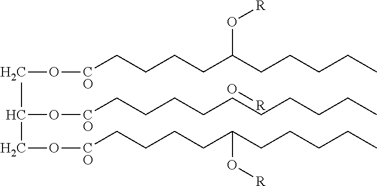 |
| | | 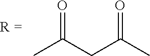 |
| | Soy fatty | epoxidized Soy fatty acid (methyl ester) |
| | acid ester, epoxidized | with epoxide rings opened with acrylic |
| | and non-epoxidized | acid |
| | (labeled AESME) | |
| Synergist | Sulfur synergist | 2-mercaptoethanol |
| Control Corrosion | Corrosion inhibitor | Imidazoline |
| inhibitor | | benzyl quat |
| | | trimethyl ammonium quat |

The bubble test simulates low flow areas where little or no mixing of water and oil occurs. The test was conducted using brine (80% of the brine being 3% sodium chloride brine and 20% of the brine being a hydrocarbon containing LVT-200. The brine was placed into kettles and purged with carbon dioxide. The brine was continually purged with carbon dioxide at 1 bar CO₂ to saturate the brine prior to starting the test for a 3 hour pre-corrode. After the test began, the test cell was blanketed with carbon dioxide one hour prior to electrode insertion and through the duration of the test to maintain saturation. The kettles were stirred at 100 revolutions per minute (rpm) for the duration of the test to maintain thermal equilibrium at 80° C.

The corrosion rate was measured by Linear Polarization Resistance (LPR) techniques. The working electrode used was carbon steel. The counter and reference electrodes were both 1018 carbon steel. The electrodes were all cleaned and polished prior to testing. Data were collected for three hours before 20 ppm of each of the compositions was dosed into its respective cell. Data were collected overnight for 21 hour test duration.

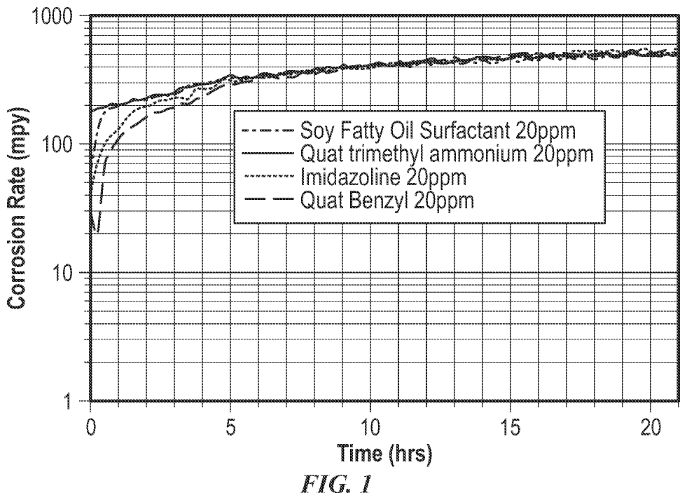

The results of the bubble test are shown in FIGS. 1-4, where the corrosion rates are measured in mpy over the 21 hour test duration. The results show corrosion rates of the composition without synergist and without other additives. The reference to ppm is parts per million, CI is corrosion inhibitor, and mpy is mils per year.

FIG. 1 shows that the evaluated soy surfactant along with all control corrosion inhibitors increased corrosion rate with time, demonstrating an initial use preference for combining with additional corrosion inhibitors, such as synergists or other actives.

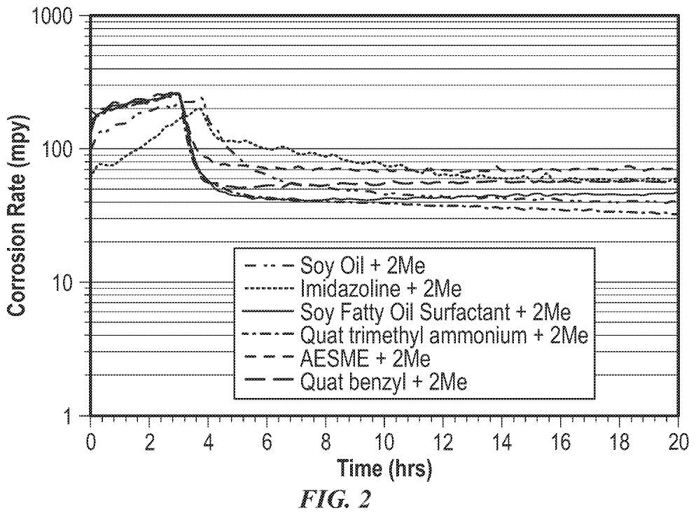

FIG. 2 shows testing combining the evaluated soy surfactant along with soy oil compared to control corrosion inhibitors with the addition of 2-mercaptoethanol (abbreviated 2ME), a sulfur synergist. All corrosion inhibition compositions were tested at 20 ppm soy-based CI composition (containing 10% soy-based CI, 5% synergist and remainder solvent). The soy surfactant along with soy oil corrosion inhibitors combined with the synergist provided comparable or improved performance compared to the conventional imidazoline and quat corrosion inhibitors.

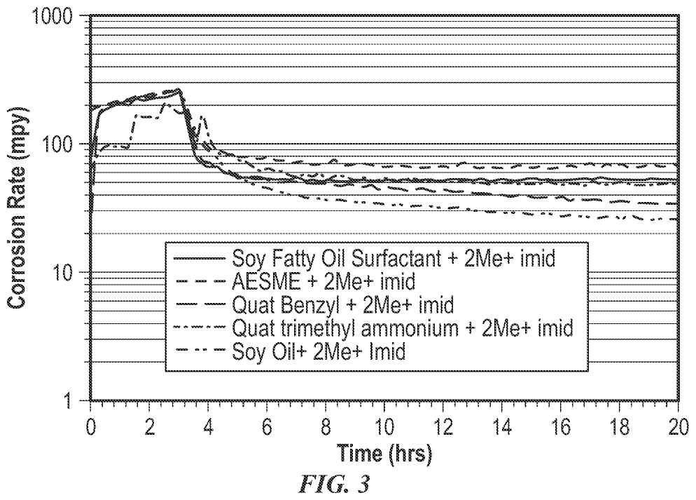

FIG. 3 shows testing combining the evaluated soy surfactant, soy oil, along with soy fatty acid ester, epoxidized and non-epoxidized, compared to control corrosion inhibitors with the addition of the 2-mercaptoethanol synergist and the corrosion inhibitor imidazoline. The testing evaluated the use of the soy-based corrosion inhibitors as a replacement for quat corrosion inhibitors. All corrosion inhibition compositions were tested at 20 ppm soy-based CI composition (containing 10% soy-based CI, 5% synergist, and 10% imidazoline). The soy-based corrosion inhibitors combined with the synergist and imidazoline represent an alternative corrosion inhibitor composition compared to conventional quats or imidazolines alone.

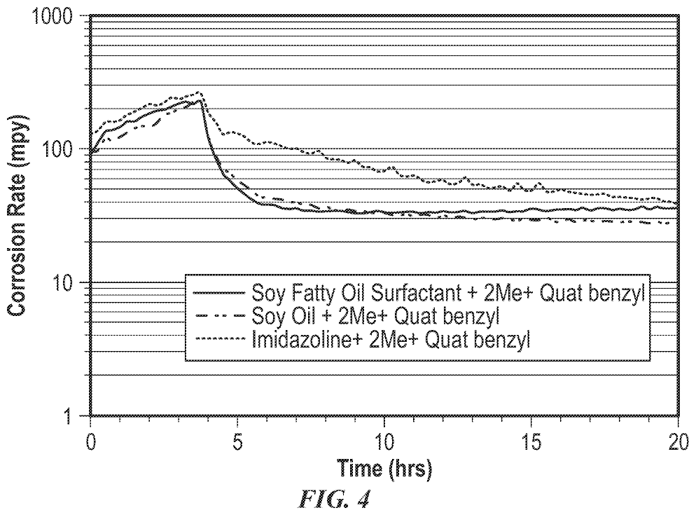

FIG. 4 shows testing combining the evaluated soy surfactant and soy oil compared to control corrosion inhibitors with the addition of the 2-mercaptoethanol synergist and the quat corrosion inhibitor. The testing evaluated the use of the soy-based corrosion inhibitors as a replacement for imidazoline corrosion inhibitors. All corrosion inhibition compositions were tested at 20 ppm soy-based CI composition (containing 10% soy-based CI, 5% synergist, and 10% imidazoline). The soy-based corrosion inhibitors combined with the synergist and quat showed improvement over the conventional CI composition of a quat/imidazoline/synergist, demonstrating the soy-based corrosion inhibitors are alternative corrosion inhibitor compositions providing the beneficial use of “green chemistries.”

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A method of inhibiting corrosion comprising:
adding a corrosive inhibiting effective amount of a composition comprising a soy-based corrosion inhibitor to an oil-field system having at least one surface and inhibiting corrosion of the at least one surface,
wherein the soy-based corrosion inhibitor comprises at least one of (i) soy oil, (ii) soy fatty acid ester, epoxidized and non-epoxidized, and (iii) an epoxidized soy fatty oil surfactant, with the structure of Formula I or II 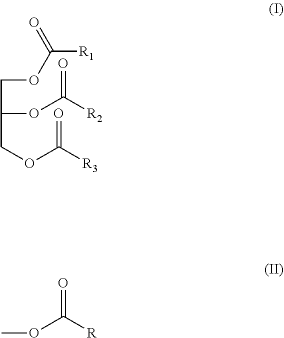
wherein:
(iₐ) for the soy oil with the structure of Formula I, R₁, R₂ and R₃ are independently selected C1-C23 hydrocarbon chains having 0 to 5 unsaturated C═C bonds wherein at least 1 bond is hydrolyzed to —OH in at least one of R₁, R₂ and R₃,
(i_{b}) for the soy oil with the structure of Formula II, R is a C1-C23 hydrocarbon chain having 1 to 5 unsaturated C═C bonds wherein at least 1 bond is hydrolyzed to —OH,
(iiₐ) for the soy fatty acid ester with the structure of Formula I, R₁, R₂ and R₃ are independently selected C1-C23 hydrocarbon chains having 0 to 5 epoxides, and wherein at least 1 epoxide is present in at least one of R₁, R₂ and R₃,
(ii_{b}) for the soy fatty acid ester with the structure of Formula II, R is a C1-C23 hydrocarbon chain having 1 to 5 epoxides,
(ii_{c}) for the soy fatty acid ester with the structure of Formula I, R₁, R₂ and R₃ are independently selected C1-C23 hydrocarbon chains having 0 to 5 epoxides, and wherein at least 1 epoxide is opened with an acrylic acid in at least one of R₁, R₂ and R₃,
(ii_{d}) for the soy fatty acid ester with the structure of Formula II, R is a C1-C23 hydrocarbon chain having 1 to 5 epoxides, and wherein at least 1 epoxide is opened with an acrylic acid,
(iiiₐ) for the epoxidized soy fatty oil surfactant with the structure of Formula I, R₁, R₂and R₃ are independently selected C1-C23 hydrocarbon chains having 0 to 5 epoxides and wherein at least 1 epoxide is opened with an amine in at least one of R₁, R₂ and R₃, or
(iii_{b}) for the epoxidized soy fatty oil surfactant with the structure of Formula II, R is a C1-C23 hydrocarbon chain having 1 to 5 epoxides and wherein at least 1 epoxide is opened with an amine.

2. The method of claim 1, wherein the effective amount is from about 1 ppm to about 200 ppm, based on the total volume of the oil-field system.

3. The method of claim 1, wherein the soy oil according to Formula I, R₁, R₂ and R₃ are independently selected C11-C21 hydrocarbon chains having 0 to 3 unsaturated C═C bonds wherein at least 1 bond is hydrolyzed to —OH in at least one of R₁, R₂ and R₃, or wherein the soy oil according to Formula II, R is a C11-C21 hydrocarbon chain having 1 to 3 unsaturated C═C bonds wherein at least 1 bond is hydrolyzed to —OH.

4. The method of claim 3, wherein the soy oil has at least 20%, at least 40%, at least 60%, at least 80%, or 100% of the unsaturated C═C bonds hydrolyzed to —OH.

5. The method of claim 1, wherein the soy fatty acid ester is according to Formula I, either (i) R₁, R₂ and R₃ are independently selected C11-C21 hydrocarbon chains having 0 to 3 epoxides, wherein at least 1 epoxide is opened with an acrylic acid in at least one of R₁, R₂and R₃, or (ii) R₁, R₂ and R₃ are independently selected C11-C21 hydrocarbon chains having 0 to 3 epoxides, wherein at least 1 epoxide is present in at least one of R₁, R₂ and R₃, or wherein the soy fatty acid ester is according to Formula II, either (i) R is a C11-C21 hydrocarbon chain having 1 to 3 epoxides, or (ii) R is a C11-C21 hydrocarbon chain having 1 to 3 epoxides and wherein at least 1 epoxide is opened with the acrylic acid.

6. The method of claim 5, wherein the soy fatty acid ester has at least 20%, at least 40%, at least 60%, at least 80%, or 100% of the epoxides opened with the acrylic acid.

7. The method of claim 1, wherein the epoxidized soy fatty oil surfactant is according to Formula I, R₁, R₂ and R₃ are independently selected C11-C21 hydrocarbon chains having 0 to 3 epoxides, wherein at least 1 epoxide is opened with the amine in at least one of R₁, R₂ and R₃, or wherein the epoxidized soy fatty oil surfactant is according to Formula II, R is a C11-C21 hydrocarbon chain having 1 to 3 epoxides and wherein at least 1 epoxide is opened with the amine.

8. The method of claim 7, wherein the epoxidized soy fatty oil surfactant has at least 20%, at least 40%, at least 60%, at least 80%, or 100% of the epoxides opened with the amine.

9. The method of claim 1, wherein the amine is —NH₂, RNH₂, or R₂NH, wherein R is independently a C1-C24 alkyl chain or (CH₂)ₓ—)OH, wherein x is 1-10.

10. The method of claim 1, wherein the composition comprises from about 1 wt-% to about 20 wt-% of the soy-based corrosion inhibitor.

11. The method of claim 1, wherein the composition further comprises from about 40 wt-% to about 90 wt-% of at least one of a synergist, additional corrosion inhibitor, and solvent.

12. The method of claim 1, wherein the composition further comprises at least one additional component selected from the group consisting of synergist, additional corrosion inhibitors, solvents, pH modifiers, surfactants, hydrate inhibitors, scale inhibitors, biocides, salt substitutes, relative permeability modifiers, sulfide scavengers, breakers, asphaltene inhibitors, paraffin inhibitors, metal complexing agents, emulsifiers, demulsifiers, iron control agents, friction reducers, drag reducing agents, flow improvers, viscosity reducers, and combinations thereof.

13. The method of claim 12, wherein the synergist comprises a mercaptan corrosion inhibitor.

14. The method of claim 1, wherein the composition is added to the oilfield system manually or automatically in either a batch or continuous manner.

15. The method of claim 1, wherein the oil-field system is a well, pipeline, fuel storage and/or transportation tanks, and/or fuel distribution system, and/or wherein the oil-field system comprises liquid that is crude oil, petroleum fuel or oil, a condensate, a distillate or cooling water.

16. The method of claim 1, wherein the oil-field system comprises one or more corrodents selected from the group consisting of oxygen, hydrogen sulfide, hydrogen chloride, carbon dioxide, sodium chloride, calcium chloride, sulfur dioxide, and combinations thereof.

17. The method of claim 1, wherein the surface comprises a metal surface.

18. The method of claim 1, wherein the oil-field system is at a temperature of about 0° C. to about 100° C.

19. The method of claim 1, wherein the composition reduces corrosion of the surface compared to a corrosive environment that does not contain the soy-based corrosion inhibitor.

20. The method of claim 19, wherein the corrosion reduction is from about 70% to about 95% for a surface comprising metal.
